(19) United States
(12) Patent Application Publication
(10) Pub. No.: US 2023/0134732 A1
(43) Pub. Date: May 4, 2023

(54) Beverage Dispensation, Preservation System and Apparatus

(71) Applicant: Vino Fontaine Pte Ltd, Singapore (SG)

(72) Inventor: Leonardus Adi PRASETYA, Zervex (SG)

(21) Appl. No.: 17/907,479

(22) PCT Filed: Mar. 27, 2020
(86) PCT No.: PCT/SG2020/050183

§ 371 Date: Sep. 27, 2022

(51) Int. Cl. B67D 1/04; B67D 1/08; B67D 1/12; B67D 3/00

(52) U.S. Cl. CPC B67D 1/0431; B67D 1/0869; B67D 1/1252; B67D 3/0038; B67D 2001/0093

(57) ABSTRACT

Disclosed is a compact system, apparatus for beverage preservation and dispensation. The system and apparatus may include a seal for attachment to a beverage container; at least a first conduit and a second conduit arranged to provide filtered air and extract beverage from the beverage container. There is a pump assembly connected to the first conduit and the second conduit to regulate air flow into and/or out of the beverage container to achieve a sub-atmospheric pressure or a super-atmospheric pressure within the beverage container.

### TECHNICAL FIELD

The present disclosure relates to a beverage dispensation and preservation system/apparatus.

### BACKGROUND

The following discussion of the background is intended to facilitate an understanding of the present disclosure only. It should be appreciated that the discussion is not an acknowledgement or admission that any of the material referred to was published, known or is part of the common general knowledge of the person skilled in the art in any jurisdiction as of the priority date of the invention.

Some beverages, such as alcoholic wine or liquors, are susceptible to degradation of quality when exposed to air. Such beverages are typically sealed to preserve quality, and when opened/unsealed for partial consumption, the beverage bottle has to be re-sealed to reduce or minimize degradation.

Apparatus and systems for the dispensation and preservation of beverages have been contemplated. One solution includes a system for resealing an opened alcohol bottle and introducing inert gases into the beverage, such as alcohol, to displace oxygen. However, such apparatus are typically bulky and expensive. In addition, the introduction of inert gases into the alcoholic beverage may degrade the quality of the same.

Another solution has contemplated the use of inert gas(es) or a sub-atmospheric/vacuum environment for preservation and a positive or super-atmospheric air pressure for dispensation. However such solution requires pressure much lower than atmospheric pressure, and pressure higher than atmospheric pressure to be generated. This may introduce additional form factor and may not be energy efficient.

Yet other systems involve the use of absorbents, such as oxygen absorbents, for the preservation of beverages. Such systems also require a large number of complicated mechanisms to achieve the oxygen adsorption/displacement.

There thus exists a need for an improved device to alleviate one or more of the aforementioned problems.

### SUMMARY

The disclosure was conceptualized to provide a relatively compact system and apparatus for beverage preservation and dispensation. The system and apparatus are particularly suited for the preservation and dispensation of alcoholic beverage such as wine and spirits or the like to preserve the quality of the same after unsealing and/or partial consumption.

According with an aspect of the disclosure there is a system for beverage preservation and dispensation comprising a seal for attachment to a beverage container, the seal having a first channel and a second channel configured to receive a first conduit and a second conduit respectively; a first pump configured to pass air through the first conduit; a first filter module arranged in fluid contact or communication with the air to be passed through the beverage container; the first filter module disposed between the first pump and the seal such that the air passing through the first conduit into the beverage container is filtered; and the second conduit arranged to urge beverage toward a dispensing mechanism for dispensation when the beverage in the beverage container is subject to a super-atmospheric pressure.

The system may form part or whole of an apparatus for the preservation and dispensation of beverage. Such an apparatus may be a stand-alone unit for attachment to a beverage container, or may be integrated with a temperature regulator, such as a cooler device.

According to another aspect of the disclosure there is a system for beverage preservation and dispensation comprising a seal for attachment to a beverage container; a first conduit arranged to remove air from the beverage container corresponding to a preservation state; a second conduit arranged to extract beverage from the beverage container corresponding to a dispensation state; a pump assembly connected to the first conduit; wherein the pump assembly is configured to produce an sub-atmospheric pressure within the beverage container for both the preservation state and the dispensation state.

In some embodiments, the beverage container is a bottle and the seal forms at least part of a bottle cap.

In some embodiments, the bottle cap includes a first channel shaped and dimensioned to receive the first conduit, and a second channel shaped and dimensioned to receive the second conduit.

In some embodiments, the bottle cap comprises at least one non-return valve positioned around at least one of the first channel and second channel to prevent passage of air into the bottle.

In some embodiments, the bottle cap includes a compartment shaped and dimensioned to receive an oxygen absorbent. The oxygen absorbent may include a carbon based absorbent or an iron based absorbent.

In some embodiments, the bottle cap is formed from silicone.

In some embodiments, the system further comprises a temperature regulated chamber for receiving the beverage container.

In some embodiments, the temperature regulated chamber comprises a double-vacuum wall with at least one sliding door.

In some embodiments, the temperature regulated chamber includes a thermoelectric cooler assembly.

In some embodiments, the thermoelectric cooler assembly includes a plurality of Peltier coolers.

In some embodiments, the system comprises an ultraviolet generator arranged to produce an ultraviolet radiation for removing microbes from the beverage.

In some embodiments, the pump assembly includes at least one motor drive and at least one syringe. The syringe may be connected to the second conduit and form part of temporary storage area for the beverage before dispensing for consumption. In some embodiments, the pump assembly may include a plurality of motor drive and/or a plurality of syringes.

According to another aspect of the disclosure there is an apparatus for beverage preservation and dispensation comprising a housing unit for housing a first pump, a first filter module and a dispensing mechanism, wherein the first pump is configured to pass air through a first conduit, the first filter module is arranged in fluid contact with air to be passed through a beverage container; the filter module disposed between the first pump and a seal such that the air passing through the first conduit into the beverage container is filtered; and a second conduit is arranged to urge beverage towards the dispensing mechanism when the beverage container is in a super-atmospheric pressure; and a seal for attachment to a beverage container, the seal having a first channel and a second channel to receive the first conduit and the second conduit respectively.

According to another aspect of the disclosure there is an apparatus for the preservation and dispensation of beverage comprising a first portion housing a preservation and dispensation assembly therein; a chamber shaped and dimensioned to receive at least one beverage container; a second portion housing a temperature regulation assembly; wherein the preservation and dispensation assembly comprises a seal shaped and dimensioned to be attached to the at least one beverage container, the preservation and dispensation assembly configured to produce an sub-atmospheric pressure within the beverage container corresponding to a preservation state and a dispensation state.

In some embodiments, the first portion, chamber, and second portion are shaped and dimensioned to form a cylindrical apparatus.

In some embodiments, the apparatus further comprises at least one temperature sensor and at least one pressure sensor.

In some embodiments, the temperature regulation assembly comprises a thermoelectric cooler assembly.

In some embodiments, the thermoelectric cooler assembly comprises a two layered Peltier cooler.

In some embodiments, the seal forms at least part of a bottle cap. The bottle cap may include a first channel shaped and dimensioned to receive the first conduit, and a second channel shaped and dimensioned to receive the second conduit.

In some embodiments, the bottle cap comprises at least one non-return valve positioned around at least one of the first channel and second channel to prevent passage of air into the bottle.

In some embodiments, the bottle cap includes a compartment shaped and dimensioned to receive an oxygen absorbent. The oxygen absorbent may include a carbon based absorbent or an iron based absorbent.

In some embodiments, the chamber comprises a sliding door mechanism, wherein the sliding door mechanism comprises a double wall.

According to another aspect of the disclosure there is a method for dispensing and preserving beverage comprising the steps of: —a. providing a first conduit arranged to introduce filtered air into a beverage container corresponding to a preservation state; b. providing a second conduit arranged to urge beverage from the beverage container to a dispensing mechanism corresponding to a dispensation state; c. providing a pump assembly connected to the first conduit and the second conduit; wherein the pump assembly is configured to produce an super-atmospheric pressure within the beverage container at the preservation state and the dispensation state.

According to another aspect of the disclosure there is a method for dispensing and preserving beverage comprising the steps of: —a. providing a first conduit arranged to remove air from a beverage container corresponding to a preservation state; b. providing a second conduit arranged to extract beverage from the beverage container corresponding to a dispensation state; c. providing a pump assembly connected to the first conduit and the second conduit; wherein the pump assembly is configured to produce an sub-atmospheric pressure within the beverage container at the preservation state and the dispensation state.

Other aspects and features of the present invention will become apparent to those of ordinary skill in the art upon review of the following description of specific embodiments of the invention in conjunction with the accompanying figures.

### BRIEF DESCRIPTION OF DRAWINGS

FIG. 1 illustrates a system for beverage preservation and dispensation according to some embodiments;

FIGS. 2a and 2b illustrates a perspective view and a side view of an apparatus for beverage preservation and dispensation according to some embodiments;

FIG. 3a shows various components of the apparatus according with some embodiments, FIG. 3b and FIG. 3c are pre-assembled or exploded view of the apparatus according with some embodiments;

FIGS. 4a and 4b shows some embodiments of the seal 102, 502 in the form of a bottle cap;

FIGS. 5a to 5e show other embodiments of a system and apparatus for beverage preservation and dispensation;

FIG. 6 shows a method for preserving and dispensing beverage according to some embodiments; and

FIG. 7 shows another method for preserving and dispensing beverage according to some embodiments.

### DESCRIPTION OF EMBODIMENTS

In order to illustrate the technical solutions to the embodiments of the present disclosure, introduction of the drawings referred to in the description of the embodiment is provided below. The drawings described below are only some examples or embodiments of the present disclosure. A person having ordinary skill in the art, without further creative effort, may apply the present disclosure to other scenarios according to these drawings.

Throughout the description, the term ‘vacuum’ refers to a pressure at well below atmospheric pressure or sub-atmospheric pressure. The term ‘vacuum’ may include pressure of 0.5 bar or less.

Throughout the description, the term ‘super-atmospheric’ pressure refers to a pressure at above 1.0 bar, and preferably around 1.5 bar.

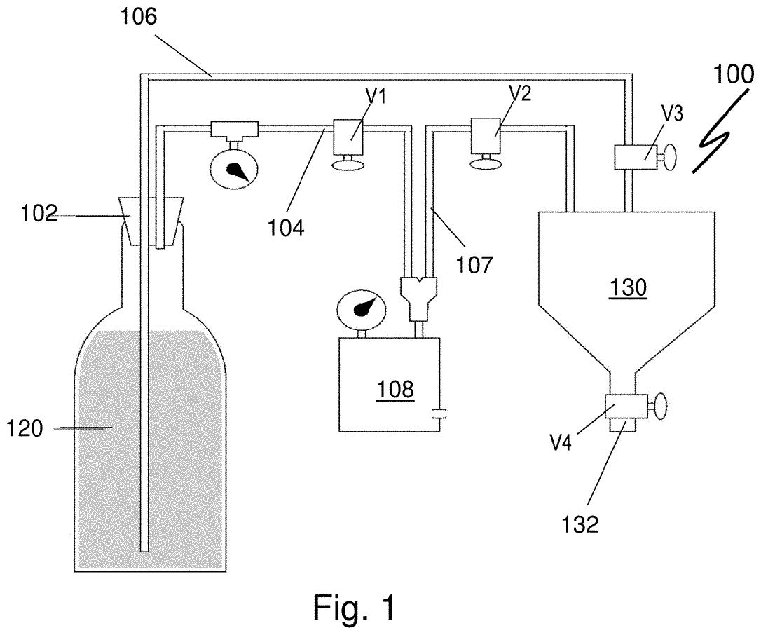

FIG. 1 shows an embodiment of a system 100 for beverage preservation and dispensation. The system 100 comprises a seal 102 for attachment to a beverage container 120; a first conduit 104 arranged to remove air from the beverage container corresponding to a preservation state; a second conduit 106 arranged to extract beverage from the beverage container corresponding to a dispensation state; a pump assembly 108 connected to the first conduit 104; wherein the pump assembly 108 is configured to produce a sub-atmospheric pressure within the beverage container for the preservation state and the dispensation state.

The beverage container 120 may be an opened wine bottle, and the seal 102 is shaped and dimensioned to seal an opening of the beverage container 120 such that air cannot enter or exit the wine bottle. In this context, the seal 102 may form part or whole of the bottle cover or cap. The seal 102 may be suitably formed from/of resilient materials, such as silicone, rubber and/or other material that can provide a hermetic sealing function.

The seal 102 may include a first channel 112 shaped and dimensioned to receive the first conduit 104, and a second channel 114 shaped and dimensioned to receive the second conduit 106. The first channel 112 and second channel 114 are suitably sealed such that only air or beverage can be removed from the beverage container 120 via the first conduit 104 and second conduit 106.

The first conduit 104 and/or second conduit 106 may be transparent flexible tubings inserted through the first channel 112 and the second channel 114 respectively. The first conduit 104 is connected to the pump assembly 108. A valve V1 is positioned at suitable location between the first conduit 104 and the pump assembly 108 to control the flow of air between the first conduit 104 and the pump assembly 108. The second conduit 106 is connected to a dispensing mechanism 130. A valve V3 is positioned at suitable location between the second conduit 106 and the dispensing mechanism 130 to control the flow of beverage between the second conduit 106 and the dispensing mechanism 130.

The dispensing mechanism 130 may be funnel-shaped for facilitating flow of the beverage to an opening 132. Flow of the beverage out of the opening 132 may be controlled by a valve V4.

The pump assembly 108 may be connected to the dispensing mechanism 130 via a third conduit 107. A valve V2 is positioned at suitable location between the pump assembly 108 and the dispensing mechanism 130 to control the flow of air between the pump assembly 108 and the dispensing mechanism 130.

Control of various aspects of the system 100, in particular the valves V1, V2, V3 and V4 may be realized by one or more controller boards (not shown). The controller board may be an electronic-based controller board may include a microprocessor, one or more sensors including pressure sensor(s), temperature sensor(s), light sensor(s), etc. The electronic board may include actuators such as buttons, power management (e.g. battery packs) and lighting units (e.g. LED lights). The controller board may be implemented as a printed circuit board assembly (PCBA).

In some embodiments, the controller board may include one or more communication module. Such communication module may be adapted to communicate in one or more wired and/or wireless communication protocols. Examples of some wireless communication protocols may include, but not limited to, Bluetooth™, 5G, Wi-Fi, etc.

In some embodiments, the bottle cap 102 comprises at least one non-return valve positioned around at least one of the first channel 112 and second channel 114 to prevent passage of air into the beverage bottle 120.

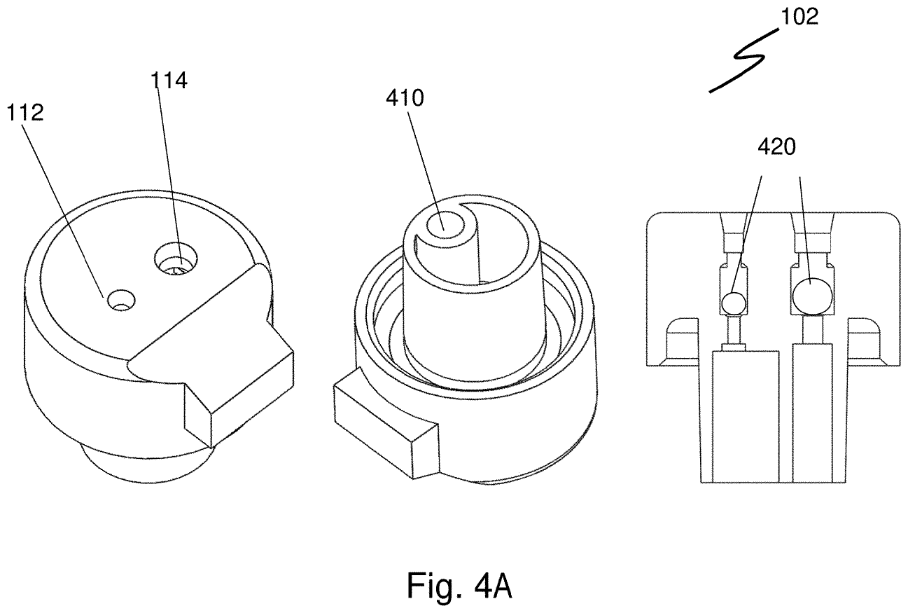

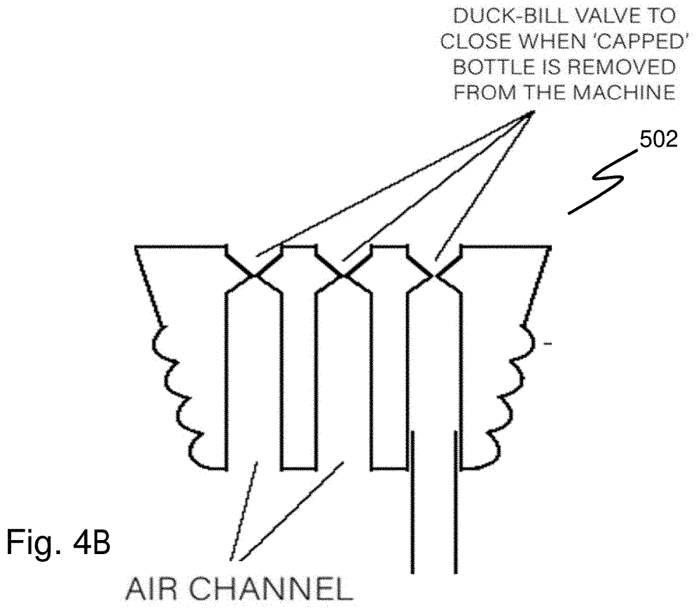

In some embodiments, the bottle cap 102 includes a compartment shaped and dimensioned to receive an oxygen absorbent. The oxygen absorbent may include at least one of a carbon based absorbent or an iron based absorbent. Further details of the bottle cap 102 will be described with reference to FIG. 4.

The system 100 for beverage preservation and dispensation will next be described in the context of its operation, in particular with reference to the preservation state and the dispensation state. The operation may commence upon detection of a beverage container 120, such as a wine bottle having seal 102 attached thereon, with the second conduit 106 contacting the beverage for dispensation.

In the preservation state, the pump assembly 108 functions as a vacuum pump to remove air from the bottle 120. The valve V1 is opened to facilitate air being drawn from the bottle 120. The air pressure within the beverage container 120 may be maintained at around 0.5 bar or less. Such an arrangement advantageously reduces the amount of oxygen within the bottle 120, hence minimizing the rate of oxidation of the beverage. In addition, the oxygen absorbent held in the seal 102 further assists in oxygen removal. The valve V1 and operation of the pump assembly 108 may be determined by pressure sensor(s). For example, the operation of the valve V1 and the pump assembly 108 may be activated if pressure within the beverage container 120 is above 0.5 bar or any other pre-determined value, as detected by the pressure sensor(s).

In the dispensation state, the valve V1 is closed. The valve V2 is opened such as to lower the pressure within the dispensing mechanism 130 (valves V3 and V4 are closed at this juncture). Once the pressure in the dispensing mechanism 130 is suitably lowered to a desired or pre-determined level which is lower than the pressure in the beverage container 120, valve V2 remains opened. Valve V3 is then opened, and beverage will flow from the beverage container 120 to the dispensing mechanism 130 by virtue of a pressure difference generated between the beverage container 120 and the dispensing mechanism 130.

Upon dispensing a desired volume of beverage, the valve V3 will be closed to prevent further beverage from entering the dispensing mechanism 130. At any time a user may then open valve V4 to release beverage from the dispensing mechanism 130 for consumption by a user.

The system 100 works on a negative pressure principle for both preservation and dispensation of beverages. Advantageously, this reduces the components or operation step(s) required for providing a positive pressure for dispensation, and/or for storage of inert gases.

In some embodiments, the system 100 may comprise an ultraviolet generator (not shown) arranged to produce an ultraviolet radiation for reducing/removing microbes from the beverage and/or from any of the mechanisms within the system 100 (e.g. first conduit 104 and second conduit 106).

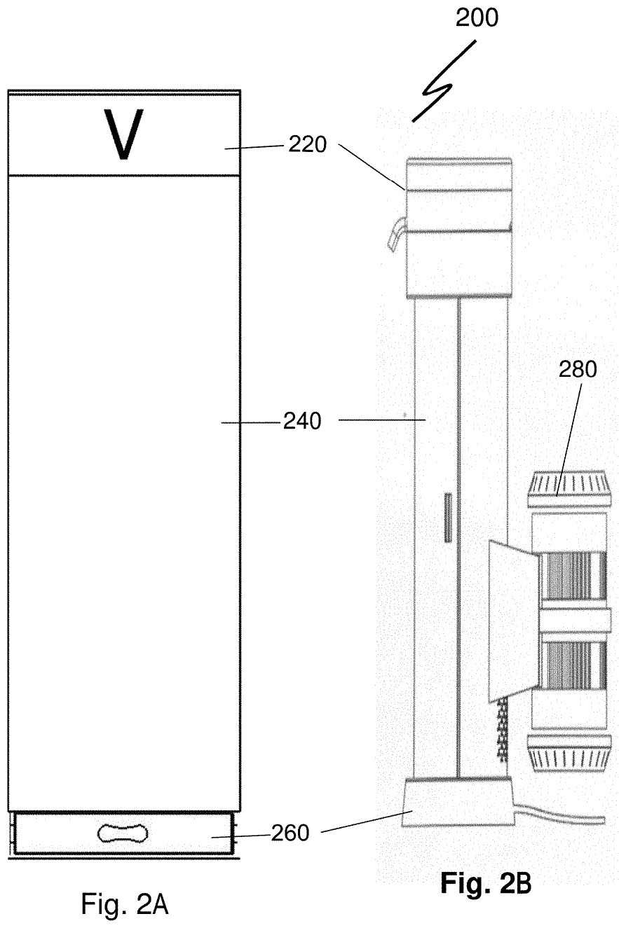

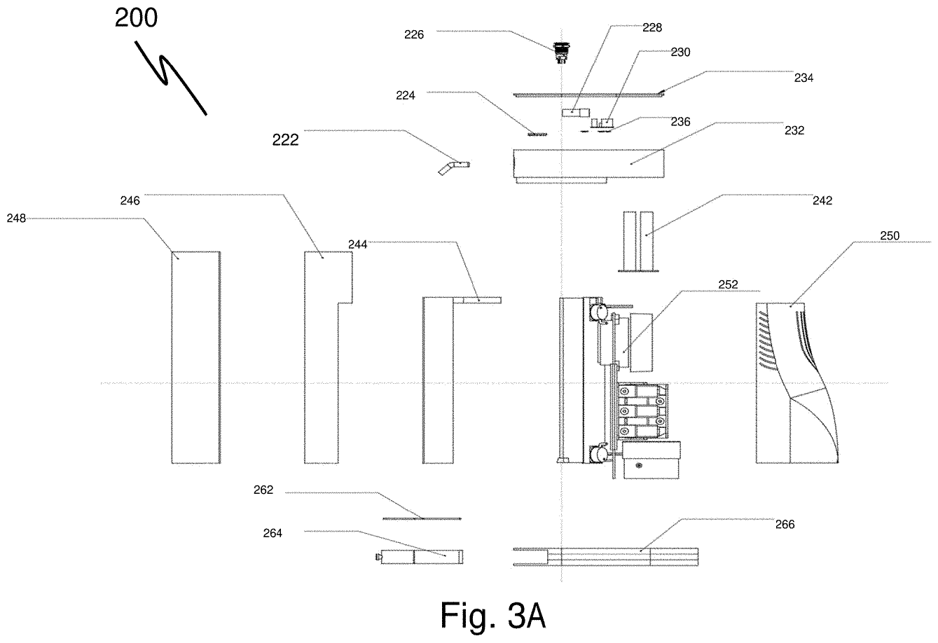

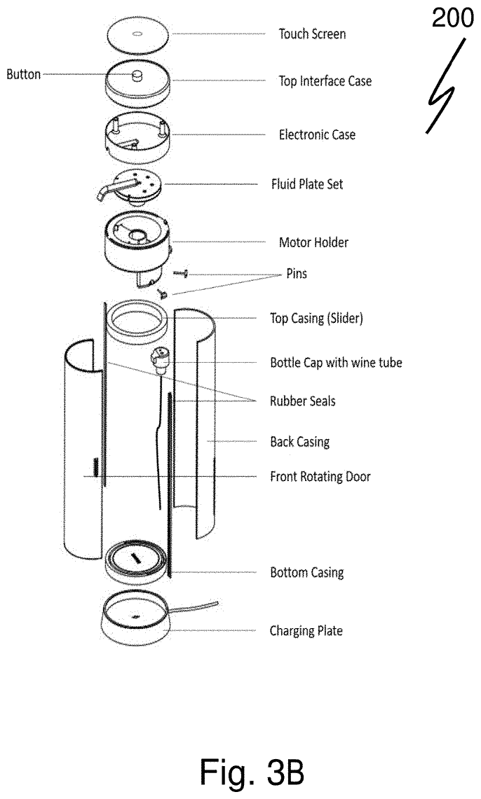

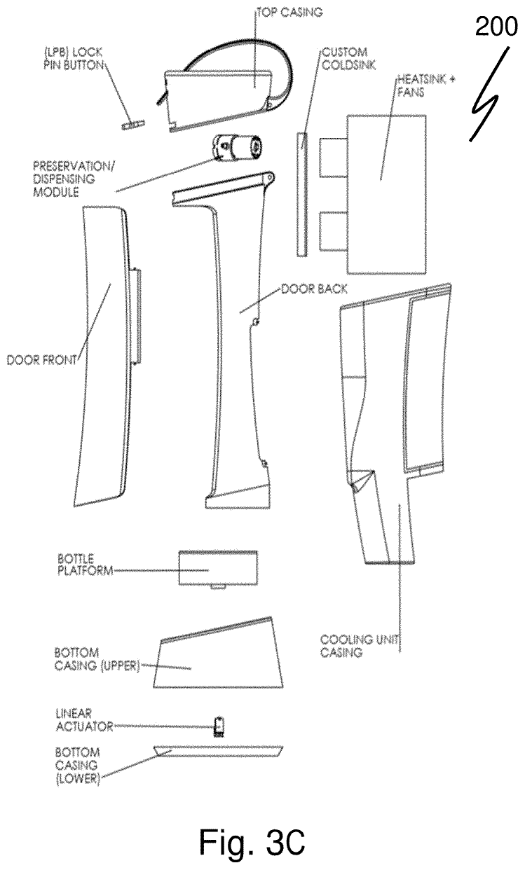

In some embodiments, the system 100 further comprises a temperature regulated chamber for receiving the beverage container. Embodiments of the chamber are described with reference to FIG. 2 and FIG. 3.

FIG. 2 shows an apparatus 200 for preservation and dispensation of beverage. The apparatus 200 comprises a first portion 220 (also referred to as a housing unit) for housing a preservation and dispensation assembly therein; a chamber 240 shaped and dimensioned to receive at least one beverage container; and a second portion 260 for housing a temperature regulation assembly. The preservation and dispensation assembly include all or some of the components as described in the system 100, and in particular comprises a seal shaped and dimensioned to be attached to the at least one beverage container 120. The preservation and dispensation assembly is configured to produce a sub-atmospheric pressure within the beverage container 120 corresponding to a preservation state and a dispensation state.

The apparatus 200 may be compacted in the form of a cylindrical structure. The first portion 220, chamber 240, and second portion 260 may be shaped and dimensioned to form a compact apparatus. The compact apparatus may be portable and easily carried and transported. In some embodiments, the compact apparatus may include curvatures adapted to be easily gripped and held by a user's hands. In some embodiments, the compact apparatus may be a cylindrical apparatus.

The chamber 240 is shaped and dimensioned to receive a beverage container, such as wine bottle 120 as described with reference to FIG. 1. As wine bottles 120 may come in a variety of shapes and sizes, the chamber 240 may be large enough to accommodate common dimensions in the market. The seal for attachment to wine bottle 120 may be configured as seal 102 having first channel 112 and second channel 114 to accommodate different openings of the wine bottle 120. The seal 102 may also include a compartment shaped and dimensioned to receive an oxygen absorbent as described. The seal may form at least part of a bottle cap.

The temperature regulation assembly may include a thermoelectric cooler assembly. The thermoelectric cooler assembly may include a two layered Peltier cooler.

In some embodiments, the chamber 240 comprises a sliding door mechanism; wherein the sliding door mechanism comprises a double wall for maintain the interior of the chamber 240 at a desired or predetermined temperature.

The double wall may be a double-vacuum wall. The sliding door is sandwiched between the two walls, with suitable rubber gaskets providing insulation. When closed, a vacuum is maintained between the walls to keep the door in position. To open the door, air may be drawn or sucked between the walls so as to draw the door open.

In some embodiments, the temperature regulated chamber includes a thermoelectric cooler assembly. In some embodiments, the thermoelectric cooler assembly includes a plurality of Peltier coolers. In some embodiments, the apparatus may comprise an ultraviolet generator arranged to produce an ultraviolet radiation for removing microbes from the beverage. This may be implemented in the form of one or more ultraviolet producing light-emitting diodes (LED) embedded on a controller of the apparatus 200. The ultraviolet LED(s) may be suitably positioned so as to direct UV radiation to a portion of the beverage container 120 or internal mechanism(s) to mitigate microbes/fungi growth and/or formation.

The thermoelectric cooler assembly may comprise a plurality of components for achieving the desired temperature regulation (e.g. cooling). The components include a plurality of heatsinks, such as a hot-side heatsink and a cool side heatsink, a plurality of fans, such as a hot-side silent fan and a cool side fan.

The thermoelectric cooler assembly is arranged so as to achieve a two-stage cooling effect. This may be achieved via a stacked configuration having a plurality of Peltier cooling plates and heatsink assembly.

FIG. 3a shows the salient components of the apparatus 200 in an un-assembled form, FIG. 3b shows the components of the apparatus 200 in an exploded form, and FIG. 3c shows another example of an apparatus 200 of a different shape to provide curvature to facilitate gripping by a human hand. When assembled, the apparatus 200 resembles the apparatus 200 as shown in FIG. 2.

As shown in FIG. 3b, the apparatus 200 may include features such as an electrical charger attached to a bottom casing of the apparatus for the provision of electrical power to the apparatus 200.

As shown in FIG. 3c, the apparatus 200 may include features such as a preservation/dispensing module configured to hold the pump assembly in a compact manner. The apparatus 200 as shown in FIG. 3c also includes a bottle platform dimensioned to hold a beverage container (such as a bottle) snugly within the casing. The bottle platform may be adjustable to suit bottles of different heights. The embodiment shown in FIG. 3c allows for a user to easily grip the apparatus 200 around a curved surface around the door front and/or door back portions.

The first portion 220 includes the following: —a dispensing spout 222 (which may form part of the dispensing mechanism), a ring of LED lights 224 for illumination, an actuator button 226 for activating the preservation and/or dispensation of the beverage, a pump assembly 228 arranged to produce a desired sub-atmospheric pressure, a controller assembly in the form of a printed circuit board (PCB) 230, a casing 232, and a casing lid 234. The first portion 220 may further include LED lights 236 for providing UV radiation or illumination.

The PCB may include integrated circuit chips (IC chips) such as application specific integrated circuits (ASIC) for control of, inter alia, the preservation and/or dispensation functions, the LEDs, the opening/closing of chamber 240, the control of various components in the second portion 260 etc.

The pump assembly 228 may be a combination of a motor and syringe to facilitate the drawing of air (preservation state) or beverage (dispensation state) out from a beverage container. Advantageously, such an arrangement achieves a relatively small form factor. In addition, in the dispensation state the syringe is suitably sterilized and of relatively small surface area and volume, so as not to adversely affect the taste and quality of the beverage passing through the syringe.

As the motor & syringe are separate mechanical parts, they may be suitably decoupled to facilitate cleansing and washing.

The chamber 240 includes the following: supporting pillars 242, centre casing 244, acrylic door backing 246, acrylic door 248 (in the form of a double-walled sliding door assembly), back casing 250, internal components 252. The supporting pillars 242 may be used to connect the first portion 220 to the chamber 240. It is contemplated that at least part or whole of the chamber 240 may be transparent so as to provide an aesthetic view of the apparatus 200 and to allow a user to view the beverage container 120. At least part of the casing 244, acrylic door backing 246, acrylic door 248, back casing 250 may be formed from transparent materials.

The second portion 260 includes the following: —drip tray grate 262, drip tray 264, and a bottom casing 266. The bottom casing 266 may include the power supply circuits for connection to an electrical mains or electrical power supply.

An embodiment of the thermoelectric cooler assembly is shown on FIG. 2b. The thermoelectric cooler assembly 280 is attached to a portion of the chamber 240 to regulate the temperature within the chamber 240. The thermoelectric cooler assembly 280 comprise a two-stage cooling assembly corresponding to Peltier plate 282 and Peltier plate 284. It is contemplated that the two-stage cooling can achieve the same cooling effect that regular coolers can, except at a smaller form factor. In other words, the two single-stage coolers are smaller and can result in space savings.

FIG. 4a shows a plan view of the seal 102, shaped and dimensioned as a wine bottle cap. The wine bottle cap is suitable for, but limited to, the re-sealing of an opened wine bottle so as to effect the preservation and/or dispensation of wine in accordance with the system 100 and/or apparatus 200. As may be seen, the wine bottle cap includes a first channel 112 and a second channel 114 for receiving respective conduits. It may be appreciated that the first channel 112 and second channel 114 may be interchanged, and is labelled for clarity and illustrative purpose only. Alternatively, the first channel 112 and second channel 114 may be of different diameters to receive the first conduit and second conduit of different sizes. The seal also comprises a compartment 410 shaped and dimensioned to receive an oxygen absorption pack. As a non-limiting example, the compartment 410 may be suited to receive an oxygen absorption pack of about 15 millilitres (ml).

Another embodiment of a seal 502 is shown in FIG. 4b. The seal 502 shown in FIG. 4b comprises three channels for receiving three conduits. The seal 502 may be shaped with friction enhancing ridges for enhancing the hermetic seal property of the same, as well as to accommodate beverage containers having openings with different dimensions. The seal 502 can also include one way valves, such as duck-bill valve, shaped to close the seal 502 when the three conduits are removed from the three channels.

The first channel 112 and second channel may include one way ball-valves 420 on the two channels 112, 114 to prevent air or fluid from flowing into the beverage container. The seal may be formed partially or wholly of silicone or other suitable materials to facilitate air-tightness.

In some embodiments, the first portion 220 may include a slidable mechanism (not shown) to slide between various positions along the longitudinal axis of the apparatus 200 so as to accommodate beverage containers of different heights. The slidable mechanism may suitably include a seal holder or attachment for holding the seal 102 to facilitate attachment to the beverage container.

The disclosure provides a system and apparatus for the preservation and dispensation of beverage. It is envisaged that the preservation comprises a combination of chemical based method and vacuum technology to at least reduce the amount of oxygen within the beverage container, such as a wine bottle. It is contemplated that the removal of air from the beverage container will remove up to 50% or more of air from the headspace from the bottle, thus reducing the oxygen content from 20% to 10% or lower from within the headspace of the beverage container. The use of an oxygen absorbent (e.g. iron powder) is targeted to absorb the remaining oxygen from 10% to less by a chemical reaction between the oxygen absorbent and the oxygen within the beverage container. It is appreciable that the chemical compound utilized in the oxygen absorbent has been tested by a regulatory, such as the food and drug administration (FDA) and may be used widely in food and beverage (F&B) preservation.

In some embodiments, the first portion 220 includes one or more fluidic plates. The fluidic plate is shaped and dimensioned to facilitate the control of valves to achieve the desired preservation and/or dispensation states. Each microfluidic plate may include one or more microfluidic chips to achieve the various functions.

In accordance with another aspect of the disclosure there is a method 600 for dispensing and preserving beverage comprising the steps of: —a. providing a first conduit arranged to remove air from a beverage container corresponding to a preservation state (step s602); b. providing a second conduit arranged to extract beverage from the beverage container corresponding to a dispensation state (step s604); c. providing a pump assembly connected to the first conduit and the second conduit (step s606); wherein the pump assembly is configured to produce an sub-atmospheric pressure within the beverage container at the preservation state and the dispensation state.

The aforementioned method may be achieved with the system 100 and/or apparatus 200. Such a method for preservation and dispensation of beverage provides for preservation and dispensation of beverage utilizing negative pressure, preferably vacuum.

It is to be appreciated that although the disclosure has been described in the context of beverage such as alcoholic beverages, the system 100 and apparatus 200 may be suited for other types of beverages, and in particular beverages that may degrade in quality due to exposure to the environment.

It is to be appreciated that the system 100 as described may be wholly incorporated as the apparatus 200, or vice-versa.

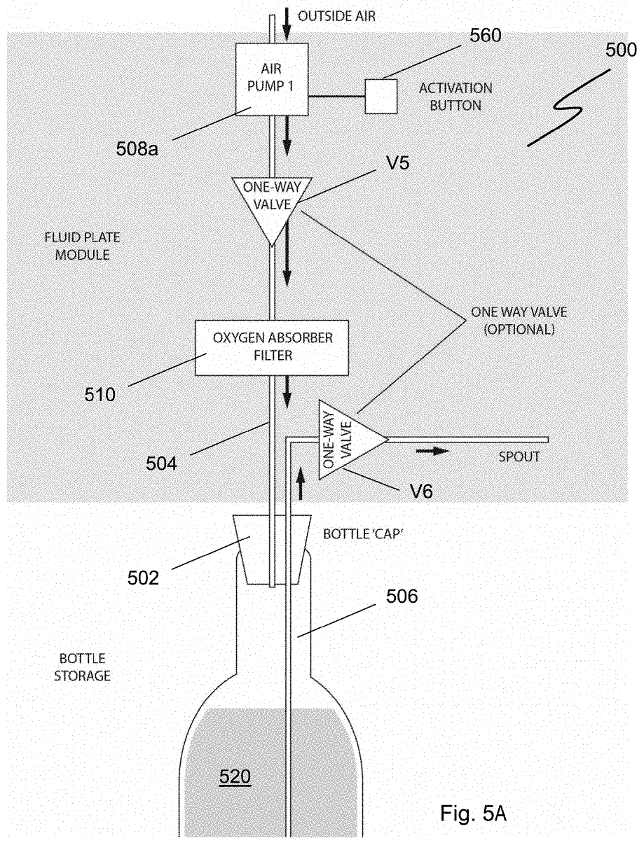

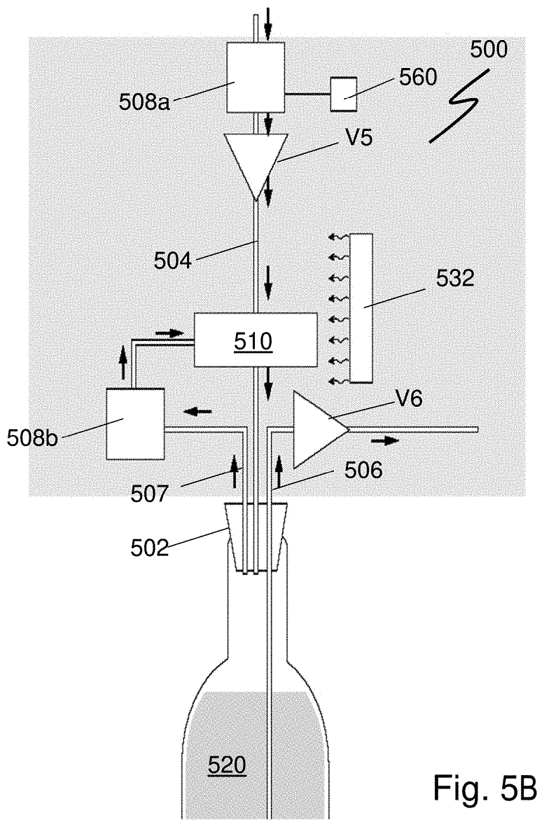

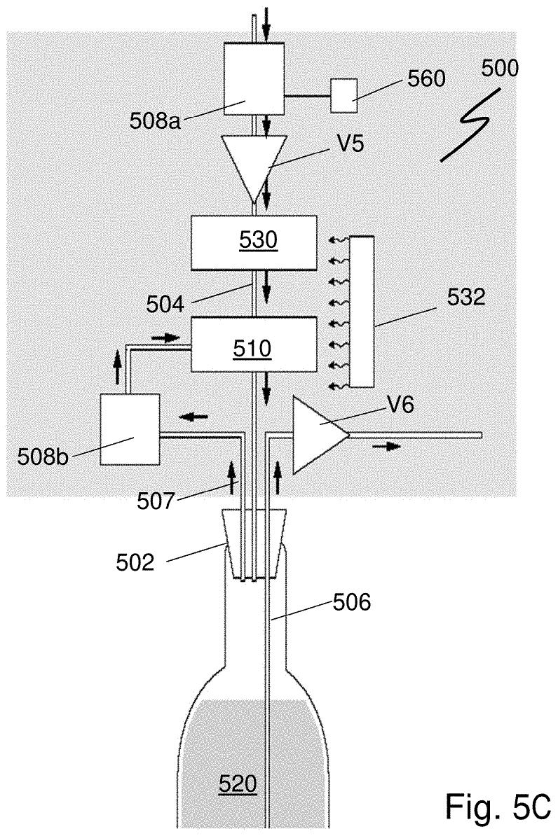

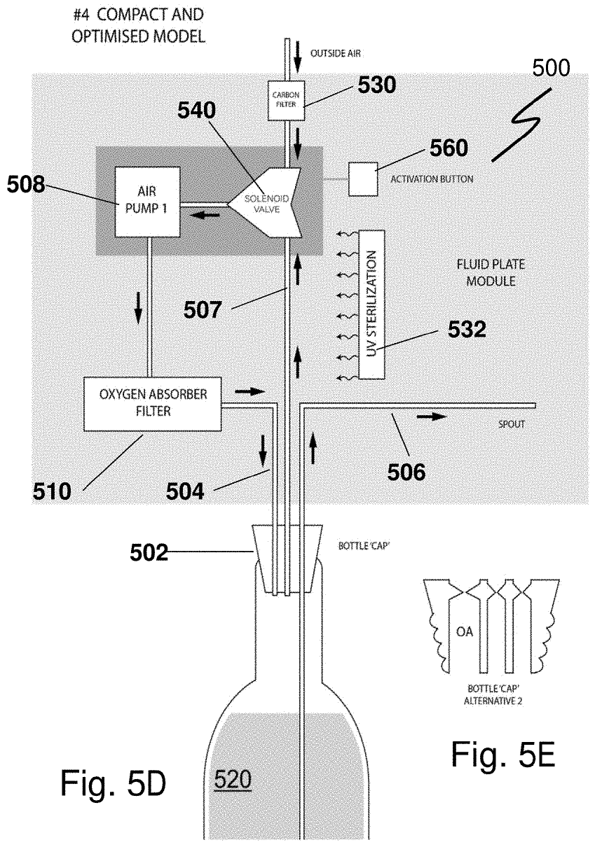

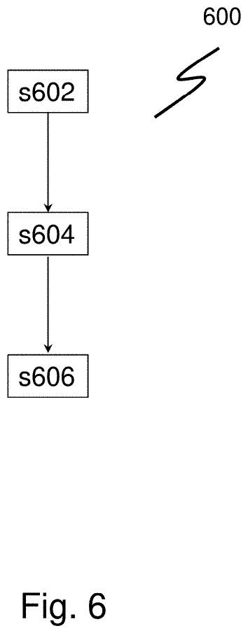

FIG. 5a, FIG. 5b, FIG. 5c, FIG. 5d and FIG. 5e show various embodiments of another system 500 for beverage preservation and dispensation. The system 500 comprises a seal 502 for attachment to a beverage container 520. Arrows in the figures denote air flow.

FIG. 5a shows an embodiment based on a ‘passive preservation’ mode. In the ‘passive preservation’ mode, there comprises a first conduit 504 arranged to introduce air into the beverage container 520 via a pump assembly 508 to increase the pressure within the beverage container 520 to a super-atmospheric pressure. Under a relatively higher pressure, beverage within the beverage container 520 is urged via a second conduit 506 to a dispensing mechanism for dispensation. The second conduit 506 is typically immersed or partially immersed in the beverage to allow the beverage to be urged into the second conduit 506. The pump assembly 508 of FIG. 5a comprising a first air pump 508a is arranged with an oxygen absorbent filter 510. The oxygen absorbent filter 510 is operable to absorb oxygen while the first air pump 508a provides a positive air-pressure within the beverage container 520 for urging the beverage within the beverage container 520 to be dispensed.

In a dispensation mode, the first air pump 508a is activated and pumps air into the first conduit 504 from the surrounding environment. The air may pass through a one-way valve into the beverage container 520. The oxygen filter 510 with oxygen absorbing reagent filters the pumped air that goes through it.

The filtered (oxygen-minimized) air is pumped into the beverage container 520, thus increasing the pressure within the beverage container 520. The beverage (for example, wine) is urged up the second conduit and dispensed, for example, via a spout mechanism.

Advantageously, every time beverage is dispensed, the percentage of oxygen in the bottle may be reduced. As beverage is dispensed, filtered air (having less percentage of oxygen) replaces the volume of the dispensed beverage, and therefore the total percentage of oxygen in the headspace of the beverage container 520 decreases although the actual amount of oxygen in the beverage container 520 remains relatively constant. In other words, due to the introduction of filtered air into the beverage container 520, the overall percentage of oxygen in the headspace is reduced.

FIG. 5b shows another embodiment of the system 500. In addition to the first conduit 504 arranged to pump air to the beverage container 520 corresponding to the passive preservation state; the second conduit 506 arranged to facilitate extraction of beverage from the beverage container corresponding to the dispensation state, the system 500 further comprises a third conduit 507 to facilitate the removal of air from the beverage container 520. In addition to the first pump 508a, the pump assembly 508 comprises a second pump 508b connected to the third conduit 507. The second air pump 508b is configured to remove air from the beverage container 520 (particularly air in the headspace) and redirect the removed air to the oxygen absorbent filter 510. The redirected air is then pumped back into the headspace of the beverage container 520 to increase the pressure within the beverage container 520 for dispensation. It is appreciable that the second air pump 508b functions as a circulation pump.

Advantageously, the system 500 shown in FIG. 5b provides for both active and passive preservation. The active preservation, facilitated by the provision of oxygen from the air in the headspace, provides for the retainment of scent and flavour of the beverage. This may be an important consideration for certain types of beverage, such as wine.

FIG. 5c shows another embodiment of the system 500 having an additional filter, such as an activated carbon filter plate 530, for removal of other particulates from the air entering the first conduit 504 via the first pump 508a. The active carbon filter plate acts as a particulate filter to remove particles of a predetermined size/range of sizes. This can remove pollutants, spores, and microorganisms in the air that are unwanted in the system.

In addition to the filter, an ultraviolet source 532, such as an ultraviolet light emitting diode (LED) lamp, may be installed to reduce microorganisms within the system 500 (see FIG. 5b and FIG. 5c). The ultraviolet source 532 may be arranged in a parallel configuration with respect to the conduits and pumps.

The dispensing of beverage shown in FIG. 5c is achieved via similar mechanisms as described in FIG. 5a and FIG. 5b. In the dispensing state, positive pressure is provided by the filtered air, via the first air pump 508a, to urge the beverage out to an outlet, such as a spout.

Advantageously, the embodiments of FIGS. 5b and 5c provide for added preservation via circulation—the initial amount of oxygen that is in the bottle when the bottle is first placed in the system may be rapidly removed and replaced with oxygen-reduced air, thus removing any potential of reaction with the wine as soon as the system 500 is activated. It is contemplated that in the preservation mode of both FIG. 5b and FIG. 5c, the air is maintained at a relatively constant pressure under the preservation mode, i.e. the rate of air entering the beverage container via the first conduit 504 and the rate of air exiting the beverage container via the third conduit 507 may be regulated to be relatively constant.

As shown in FIG. 5a to FIG. 5c, optional one-way valves V5, V6 may be positioned between the first air pump 508a and the seal 502, and between the third conduit 507 and spout respectively.

In some embodiments, one or more oxygen sensors may be positioned within the system 500 to detect the presence of oxygen in the system 500. If the sensor detects that filtered air passing through the oxygen absorber filter 510 has a higher than predetermined level of oxygen, the pump assembly 508 may be configured to pump or circulate air through the filter 510 until the oxygen levels are acceptable. Any higher than detected level of oxygen may indicate that one or more components of the filter needs to be replaced. In addition or as an alternative, a counter may be incorporated into the control circuits to count the number of days since the filter was last changed in order to estimate the remaining lifespan of the filter before it needs to be maintained or changed.

FIG. 5d shows another embodiment of the system 500 having a single air pump 508 to control air flow into the bottle 520 in association with both the preservation state and the dispensing state. Advantageously, the embodiment of FIG. 5d provides for an active preservation mode and a dispensing mode using only a single pump 508. A valve, such as a solenoid valve 540, is arranged to control or regulate the air flow into the beverage container 520. The first filter module, i.e. an oxygen filter 510 is arranged or positioned between the single air pump 508 and the bottle cap/seal 502. A second filter module 530, such as, but not limited to, a carbon filter, may be arranged or positioned to filter environmental air entering into the system 500 before the air passes to the solenoid valve 540 and the air pump 508. Similar to other embodiments, an ultraviolet source 532, such as an ultraviolet light emitting diode (LED) lamp, may be installed to reduce microorganisms within the system 500 may be arranged in a parallel configuration with respect to the conduits 504, 507 and single pump 508.

Under a preservation mode, air will be drawn and introduced into the system 500 via the air pump 508. The air introduced into the system 500 will pass through the carbon filter 530, the solenoid valve 540, and then directed to the oxygen absorption filter 510. The filtered air will be directed into the beverage container 520 via the first conduit 504 and the recirculated to the air pump 508 via the third conduit 507 and re-introduced into the beverage container 520 via the first conduit 504. It is envisaged that such an arrangement will over time reduce the amount of oxygen within the beverage container 520 and thus achieves a desired preservation.

It is contemplated that in the dispensing mode associated with the embodiments of FIGS. 5a, 5b, 5c, and 5d, an activation button 560 will be used to activate the air pump 508 and/or solenoid valve 540 to draw air from the ambient environment, through the air pump 508 and oxygen absorbent filter 510, thereby creating a super-atmospheric pressure in the bottle 520 for urging wine out via the second conduit 506 through the dispensing mechanism such as a spout.

In some embodiments, a microcontroller is present to control the air pump 508 and the solenoid valve 540 for preservation and dispensing.

FIG. 5e shows another possible variation where the oxygen absorption filter 510 is disposed within the bottle cap 502. In such embodiment the oxygen absorption filter 510 may be arranged such that air exiting from the first conduit 504 is directed pass the oxygen absorption filter within the seal 502.

In some embodiments, the system 500 together with the seal 502 may form a portable unit for connection with a wine bottle. The whole system can be placed together into a temperature regulated environment, such as a refrigerator.

The system 500 may form part of an apparatus for preservation and dispensation of beverage, such as the apparatus 200 depicted in FIG. 2 and FIGS. 3a, 3b and 3c. The apparatus may be suited for the preservation and dispensation of wine.

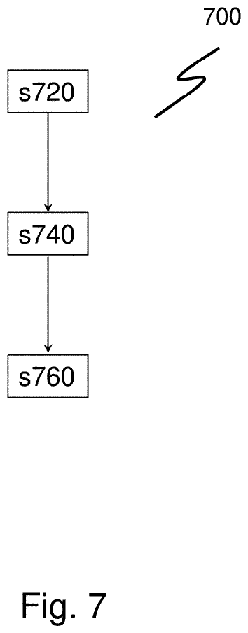

According with another aspect/embodiment and with reference to FIG. 7 there is a method 700 for dispensing and preserving beverage comprising the steps of: —a. providing a first conduit arranged to introduce filtered air into a beverage container corresponding to a preservation state (step s720); b. providing a second conduit arranged to urge beverage from the beverage container to a dispensing mechanism corresponding to a dispensation state (step s740); c. providing a pump assembly connected to the first conduit and the second conduit (step s760); wherein the pump assembly is configured to produce an super-atmospheric pressure within the beverage container at the preservation state and the dispensation state.

It is contemplated that the various features of the system 100 and system 500 may be combined to form further embodiments falling within the intended scope of the invention.

It will now be apparent that a new, improved dispensation and preservation system and apparatus has been described in the specification with sufficient particularity as to be understood by one of ordinary skill in the art. Moreover, it will be apparent to those skilled in the art that various modifications, variations, substitutions and equivalents exist for features of the apparatus and system which do not materially depart from the scope of the invention.

It should be further appreciated by the person skilled in the art that variations and combinations of features described above, not being alternatives or substitutes, may be combined to form yet further embodiments falling within the intended scope of the invention.

1. A system for beverage preservation and dispensation comprising:
a seal for attachment to a beverage container, the seal having a first channel, a second channel and a third channel to receive a first conduit, a second conduit and a third conduit respectively;
a pump assembly configured to direct air through the first conduit; and
a first filter module arranged in fluid contact or communication with the air to be passed through the first conduit into the beverage container during beverage preservation,
the second conduit arranged to urge beverage toward a dispensing mechanism for dispensation when the beverage in the beverage container is subject to a pressure, and
wherein the third conduit is connected to a valve for extraction of air from the beverage container via the pump assembly and the pump assembly is configured to redirect the extracted air to the first conduit.

2. The system of claim 1, wherein the third conduit is arranged in fluid communication with the first filter module, and the pump assembly is configured to redirect the extracted air to the first conduit via the first filter module.

3. (canceled)

4. The system of claim 1, wherein the first filter module comprises an oxygen absorption filter.

5. The system of claim 1, further comprising an ultra-violet sterilization module arranged to direct ultra-violet radiation to the first filter module, the second filter module, and the first conduit.

6. The system of claim 2, further comprising a one-way valve to prevent backflow of air back to the pump assembly.

7. (canceled)

8. The system of claim 1, wherein at least one of the first filter module and the second filter module is integrated with the seal.

9. An apparatus for beverage preservation and dispensation comprising:
a housing unit for housing a pump assembly, a first filter module and a dispensing mechanism,
wherein the pump assembly is configured to pass air through a first conduit, the first filter module is arranged in fluid contact with air to be passed through a beverage container during beverage preservation; and a second conduit is arranged to urge beverage towards the dispensing mechanism when the beverage container is subject to a pressure; and
a seal for attachment to a beverage container, the seal having a first channel, a second channel and a third channel to receive the first conduit, the second conduit and the third conduit respectively,
wherein the third conduit is connected to a valve for extraction of air from the beverage container via the pump assembly and the pump assembly is configured to redirect the extracted air to the first conduit.

10. The apparatus of claim 9, wherein the housing unit further houses a second filter module, the second filter module arranged in series with the first filter module.

11. The apparatus of claim 9, wherein the third conduit is arranged in fluid communication with the first filter module, and the pump assembly is configured to redirect the extracted air to the first conduit via the first filter module.

12. The apparatus of claim 9, wherein the housing unit further houses an ultra-violet sterilization module arranged to direct ultra-violet radiation to the first filter module, the second filter module, and the first conduit.

13. A system for beverage preservation and dispensation comprising
a seal for attachment to a beverage container;
a first conduit arranged to remove air from the beverage container corresponding to a preservation state;
a second conduit arranged to extract beverage from the beverage container corresponding to a dispensation state;
a pump assembly connected to the first conduit and the second conduit;
wherein the pump assembly is configured to produce a pressure within the beverage container at the preservation state and the dispensation state.

14. The system of claim 13, wherein the beverage container is a bottle and the seal forms at least part of a bottle cap.

15. The system of claim 14, wherein the bottle cap includes a first channel shaped and dimensioned to receive the first conduit, and a second channel shaped and dimensioned to receive the second conduit.

16. The system of claim 14, wherein the bottle cap comprises at least one non-return valve positioned around at least one of the first channel and second channel to prevent passage of air into the bottle.

17-38. (canceled)

39. The system of claim 1, further comprising one or more oxygen sensors configured to detect the presence of oxygen in the system.

40. A method for dispensing and preserving beverage comprising the steps of:
providing a first conduit arranged to introduce air into a beverage container corresponding to a preservation state;
providing a second conduit arranged to urge beverage from the beverage container to a dispensing mechanism corresponding to a dispensation state;
providing a pump assembly connected to the first conduit and the second conduit; and
providing a third conduit arranged to extract air from the beverage container via the pump assembly, wherein the pump assembly is configured to redirect the extracted air through a first filter module to the first conduit,
wherein the pump assembly is configured to produce a pressure within the beverage container at the preservation state and the dispensation state.

41. The method of claim 40, wherein the first filter module comprises an oxygen absorption filter.
